(19) United States
(12) Patent Application Publication
(10) Pub. No.: US 2009/0202880 A1
(43) Pub. Date: Aug. 13, 2009

(54) ELECTROCHEMICAL MEDIATORS

(76) Inventors: Yi Ge, Meir (GB); Paula Pizarro De Sousa Brito, Cranfield (GB); Anthony Peter Francis Turner, Wilstead (GB)

Correspondence Address: STITES & HARBISON PLLC, 1199 NORTH FAIRFAX STREET, SUITE 900, ALEXANDRIA, VA, 22314, US

(21) Appl. No.: 12/263,734

(22) Filed: Nov. 3, 2008

(30) Foreign Application Priority Data
Nov. 1, 2007 (GB) 0721557.7

(51) Int. Cl. H01M 8/10; C25B 11/04; G01N 27/26

(52) U.S. Cl. 429/30; 204/290.11; 204/400; 252/182.1

(57) ABSTRACT

A redox mediator is a hyperbranched polymer having redox moieties (e.g. ferrocene) incorporated into its structure and/or chemically bonded to its periphery. It is attached to an electrode and assists in transferring electrons between the electrode and a redox enzyme.

### BACKGROUND OF THE INVENTION

The present invention relates to electrochemical mediators and their use in electrochemical-based sensors and enzyme-based biofuel cells. The mediators may be immobilised on an electrode.

The present invention relates, in general, to polymeric mediators, their production and uses.

Electrochemical-based sensors and enzyme-based biofuel cells both contain a system where one or more redox mediator(s) and one or more redox enzyme(s) are used in conjunction with one or more electrode(s). The redox mediator is a molecule which can shift between oxidised and reduced states and thereby facilitate electron transfer between the reactive centre of an enzyme and an electrode surface. Direct electron transfer from enzyme to electrode is difficult since the reactive centres in most redox enzymes are well protected and deeply buried underneath the protein shells. Such mediators as ferrocene derivatives, quinones and bipyridinium salts have been widely studied and used. For example, the mediator pyrroloquinoline quinone (PQQ) was used with glucose oxidase as an anodic biocatalyst in a glucose-based biofuel cell (N. Yuhashi et al., Biosensors and Bioelectronics (2005) 20, 2145-2150).

For a continuous or semi-continuous shuttling of electrons between the electrode and the mediator, it is essential that the electron mediator does not leach from the vicinity of the electrode. In addition, the leaching of harmful mediators would be a hazard to the host such as humans. In order to prevent leaching, chemical compositions of the mediators where these are chemically attached to the electrodes and/or to the catalytic enzymes have been investigated. However, the loading of mediators on the electrodes is low and the conjugated mediator-enzymes suffer from a deleterious decrease in enzyme activity.

Redox polymers have successfully shown their abilities to overcome the leaching problem with additional advantages:

1) Control of the reaction rate by the applied potential or current;

2) Close proximity of electrocatalytic sites to the electrode;

3) High concentration of active centres despite the low amount of material required.

Typically, a redox polymer consists of a system where a redox-active transition metal based pendant group is covalently bound to some sort of polymer backbone, which may or may not be electroactive. Certain redox mediators can also be polymerised or cross-linked with/without other monomers. Nonetheless, they suffer from low flexibility, reduced mediation activity, limited mediation capacity and poor process ability.

Dendrimers, like conventional polymers, are built from smaller repeating subunits, but instead of forming linear chains, the subunits branch out in a well-defined pattern from a central point. Through either divergent or convergent syntheses, dendrimers can be made with high regularity and controlled molecular weight, and can be characterised by their structural perfection. These macromolecules consist of a multi-functional central core (or focal point) covalently linked to layers of repeating units and a number of terminal groups.

Dendritic mediators (C. M. Casado et al., Coordination Chemistry Reviews (1999) 185-186, 53-79) comprising the dendritic structure and redox mediator moieties have attracted great interest in the fields of sensors and biofuel cells, since they could not only facilitate electron shuttling between the redox enzyme and electrode like other conventional redox polymers, but also provide precise structure and size control, improved physical and chemical properties such as high flexibility, low viscosity, high solubility and miscibility, together with enormous and functional surface and interior areas. Another big advantage is their ability to encapsulate or bind guest molecules such as redox enzymes, leading to stable electron shuttling because of the closer and substantial contact. However, as with other dendrimers, dendritic mediators also have intrinsic disadvantages: time-consuming synthesis, difficult purification, high cost and low yield, particularly for the high molecular weight ones. For the use as engineering materials, they are far too complicated and costly to produce.

Hyperbranched polymers (HBPs) are a young and rapidly growing area within the field of macromolecules. HBPs and dendrimers belong to the same group of polymers with densely branched structures and a large number of reactive groups. As a result, they have some similar properties such as low viscosity, good solubility, and multi-functionality. They also have the potential ability to encapsulate or bind guest molecules. However, dendrimers are defined as monodisperse macromolecules. That is, a dendrimer material is composed of molecules that are uniform with respect to relative molecular mass and constitution. In contrast, HBPs are polydisperse. Compared to dendrimers, HBPs show some great and distinguishable advantages including simplified synthesis, easy purification, high yield and reasonable cost, which make them much more suitable for industrial manufacture.

The structural difference between these two types of polymers is that while dendrimers have a well defined structure and have a degree of branching of 100% (all branches are “occupied” with the next branch), Hyperbranched polymers are polydispersed macromolecules having irregular and highly branched structures. Hyperbranched polymers can be synthesised in just one-pot step and the fundamental synthesis approaches differ between the two. Whereas dendrimers require absolute control of all synthesis steps, manufacturing of ordinary hyperbranched polymers is accomplished by a simplified approach.

Synthetically, dendrimers can be achieved mainly in three ways: i) a central core which is either a single atom or an atomic group having at least two identical functions, ii) branches emanating from the core, constituted of several repeating units having at least one branch junction, iii) many terminal functional groups, generally located in the exterior of the macromolecule.

Hyperbranched polymers, on the other hand, do not need a central core to grow, they are synthesised using a one step polymerisation of ABₓ type multifunctional monomers or A₂+B₃ type comonomers. Furthermore the functional groups are not necessarily located in the exterior of the macromolecule.

Adding to these structural and synthetic differences they posses the same physical properties as dendrimers such as low-viscosity, good solubility and multifunctionality and both posses “tree”-alike structure. Thus, in some ways, hyperbranched polymers can be considered as the alternative of dendrimers but having much easier synthesis.

Ordinary crosslinked polymers have a main structural difference towards hyperbranched polymers. Crosslinked polymers are essentially constituted of macromolecules that were formed with bonds that link one polymer chain to another forming, therefore, a “net” structure. These are not branches that grew from the functional groups of the monomers. Crosslinked polymers are polymers chains linked to one another.

### SUMMARY OF THE INVENTION

It is therefore an object of the present invention to disclose the use of polymeric mediators and, in particular, of hyperbranched polymeric mediators, in electrochemical-based sensors and enzyme-based biofuel cells.

In a first aspect the invention provides an electrode assembly comprising an electrode and a redox mediator associated with the electrode so that in use it facilitates transfer of electrons between the electrode and a further entity, wherein the redox mediator comprises a hyperbranched polymer including a plurality of redox mediator moieties.

In a second aspect the invention provides a redox mediator which comprises a hyperbranched polymer including a plurality of redox mediator moieties.

According to embodiments of the present invention, the use of hyperbranched polymeric mediators in electrochemical-based sensors and enzyme-based biofuel cells prevents the leaching of unfixed mediators from the vicinity of electrodes while maintaining or improving the mediation activity. In addition, the materials can be compatible with enzymes.

According to embodiments of the present invention, the modified electrochemical-based sensors and enzyme-based biofuel cells include an electrode to which at least one hyperbranched polymeric mediator is attached.

According to embodiments of the present invention, for use in electrochemical-based sensors or enzyme-based biofuel cells, a hyperbranched polymeric mediator is provided which comprises a plurality of at least one kind of redox mediators (e.g. ferrocene-based redox mediators). The redox mediator(s) may be chemically incorporated within the HBP or chemically anchored on the periphery of the HBP, or both.

According to embodiments of the present invention, for the use in an electrochemical-based sensors and an enzyme-based biofuel cell, a method of preparing a hyperbranched polymeric mediator is provided. The redox mediator(s) may be polymerised with/without additional monomer(s) to form a hyperbranched polymeric mediator. The redox mediator(s) may also be introduced via surface modification after the polymerisation to produce an HBP.

According to embodiments of the present invention, for the use in an electrochemical-based sensors and an enzyme-based biofuel cell, a hyperbranched polymeric mediator HBP is provided which is prepared according to the above-stated method.

According to embodiments of the present invention, a method of either physically (e.g. printing) or chemically (e.g. covalent binding) attaching at least one hyperbranched polymeric mediator to an electrode (e.g. gold electrode) is provided. The attachment can be either direct attachment (e.g. grafting to the surface) or indirect attachment (e.g. sandwich structure with additional material). The additional material may comprise nanomaterials (e.g. nanotube), conductive or semi-conductive polymers (e.g. polypyrrole), metal (e.g. platinum), carbon, and any combination thereof.

According to embodiments of the present invention, an electrode with at least one immobilised hyperbranched polymeric mediator is provided which is prepared according to the above-stated method.

### BRIEF DESCRIPTION OF THE DRAWINGS

FIG. 1(a) to (d) are simplified schematic depictions of 4 types of hyperbranched polymeric mediator according to embodiments of the present invention;

FIG. 2 shows a simplified schematic depiction of a reaction for synthesising a hyperbranched polymeric mediator according to an exemplary embodiment of the present invention.

FIG. 3 shows another simplified schematic depiction of a reaction for synthesising a hyperbranched polymeric mediator according to an exemplary embodiment of the present invention.

FIG. 4 shows a simplified schematic depiction of chemically direct attachment of a hyperbranched polymeric mediator to an electrode according to an exemplary embodiment of the present invention.

FIG. 5 shows a another simplified schematic depiction of chemically direct attachment of a hyperbranched polymeric mediator to an electrode according to an exemplary embodiment of the present invention.

FIG. 6 shows results of cyclic voltammetry experiments.

### DETAILED DESCRIPTION OF THE PREFERRED EMBODIMENTS

To be consistent throughout the present specification and for clear understanding of the present invention, the following definitions are hereby provided for terms used therein:

The term “redox mediator” refers to any chemical moiety capable of undergoing a reduction or oxidisation with both an enzyme and an electrode surface.

The term “hyperbranched polymeric mediator” refers to a HBP containing a plurality of at least one kind of redox mediator.

HBPs are phenomenologically different from linear polymers (e.g. lower viscosity). They further show various advantages over dendrimers such as simplified synthesis, easy purification, high yield and reasonable cost. By the incorporation and attachment of redox mediator(s) in/on the hyperbranched polymer, it is able to generate a new material (hyperbranched polymeric mediator) with some advanced properties, such as high functionality and easy preparation, which are particularly useful for electrochemical-based sensors and enzyme-based biofuel cells to efficiently prevent the leaching of unfixed mediators from the vicinity of electrodes and facilitate the attachment to electrodes, while still maintaining the mediation activity. The mediation activity can even be improved by using a conjugated or conductive hyperbranched polymeric mediator.

Moreover, since HBPs can have the ability to encapsulate or bind guest molecules such as redox enzymes (e.g. glucose oxidase), the hyperbranched polymeric mediators will provide a new platform for reformative and stable electron shuttling because of the closer and substantial contact with guest molecules.

In addition, a hyperbranched polymeric mediator (“HBPM”) can be compatible with enzymes due to the surface of a HBP is highly functional (numerous terminal groups) with further opportunity to be modified if necessary. For example, a hyperbranched polymeric mediator (e.g. ferrocene-containing hyperbranched polyglycerol) having hydroxyl terminal groups on the surface is more hydrophilic and thus can be compatible with enzymes.

FIG. 1 is a schematic depiction of a HBPM according to embodiments of the present invention. The large circles 1 represent a hyperbranched polymer macromolecule. The small circles represent mediator moieties. In FIGS. 1a and 1b, there is only one kind of mediator moiety 2. FIG. 1a shows a HBPM in which the mediator moieties 1 are incorporated within the polymer molecule. FIG. 1b shows an HBPM in which the mediators 2 have been anchored to the surface of a preformed polymer macromolecule 1. FIGS. 1c and 1d correspond to FIGS. 1a and 1b respectively, but show HBPMs having two different kinds of mediator moiety 2,3. According to the present invention, the suitable redox mediators may include, but are not limited to, moieties based on one or more of ferrocenyl redox mediators, ferri/ferrocyanide redox mediators, quinone redox mediators, osmium redox mediator complexes, methylene blue redox mediators, 2,6-dichloroindophenol redox mediators, thionine redox mediators, gallocyanine redox mediators, indophenol redox mediators, ethyl phenazene redox mediators, and any combinations thereof.

The redox mediator(s) can be chemically incorporated within a hyperbranched polymeric mediator via covalent bonds (FIGS. 1a and c). A hyperbranched polymeric mediator can be synthesised via an A₂+B₃ approach, where group A is readily reactive with group B in the presence of a suitable catalyst (e.g. an acid or a base). Herein, the functional redox mediator could either be A₂ or B₃ type.

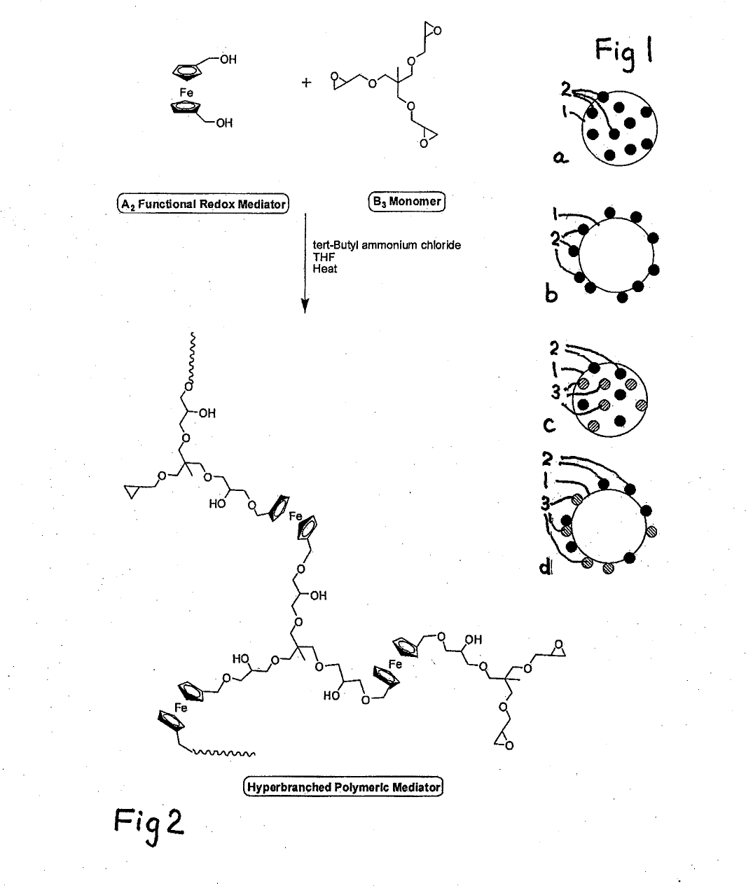

For example, FIG. 2 is a simplified depiction of a reaction for synthesising a hyperbranched polymeric mediator according to an exemplary embodiment of the present invention. The reaction is a ring-opening polymerisation of an A₂ type functional redox mediator with a B₃ type functional monomer. The product is an HBP incorporating covalently attached redox mediator moieties (namely, ferrocene moieties). As will be described in the Examples below, such a hyperbranched polymeric mediator is useful in electrochemical-based glucose sensors.

The synthetic approach for a hyperbranched polymeric mediator may also include the polycondensation of an ABₓ (x≧2) type redox mediator, the self-condensation vinyl polymerisation of an AB* type redox mediator (* represents a reactive site which can initiate the polymerisation) and multi-branching ring-opening polymerisation of a latent ABₓ type redox mediator.

The redox mediator(s) can also be chemically anchored on the periphery of the HBP via surface modification (FIGS. 1b and d). In other words, at least one redox mediator can be introduced and covalently bond to the surface of a prepared HBP. The functional end groups on the periphery of a HBP for such modification may include hydroxy, halide, carboxyl acid, carboxyl halide, amide, and amine groups.

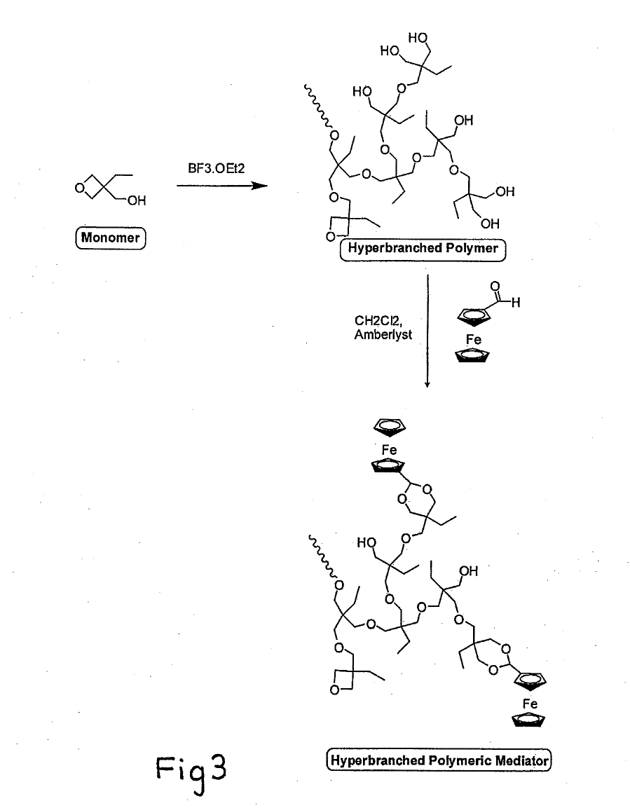

One example for synthesising another hyperbranched polymeric mediator is depicted in FIG. 3 according to an exemplary embodiment of the present invention. The reaction sequence includes the initial synthesis of a HBP and subsequent surface modification via a ring-forming reaction. The system can be recognised as a HBP bearing covalently attached redox mediator moieties on the periphery (namely, ferrocene caps).

The attachment of at least one hyperbranched polymeric mediator to an electrode, according to embodiments of the present invention, can be divided into two categories: direct attachment and indirect attachment. The electrode can include carbon electrodes, metal electrodes, polymer electrodes, and any combinations (namely, hybrid electrodes) thereof. The attachment can be either physical (e.g. printing) or chemical (e.g. covalent binding).

For direct attachment, at least one hyperbranched polymeric mediator is directly immobilised on the surface of an electrode. Examples of such physically direct attachment are coating, printing, dipping and hydrophobic interaction.

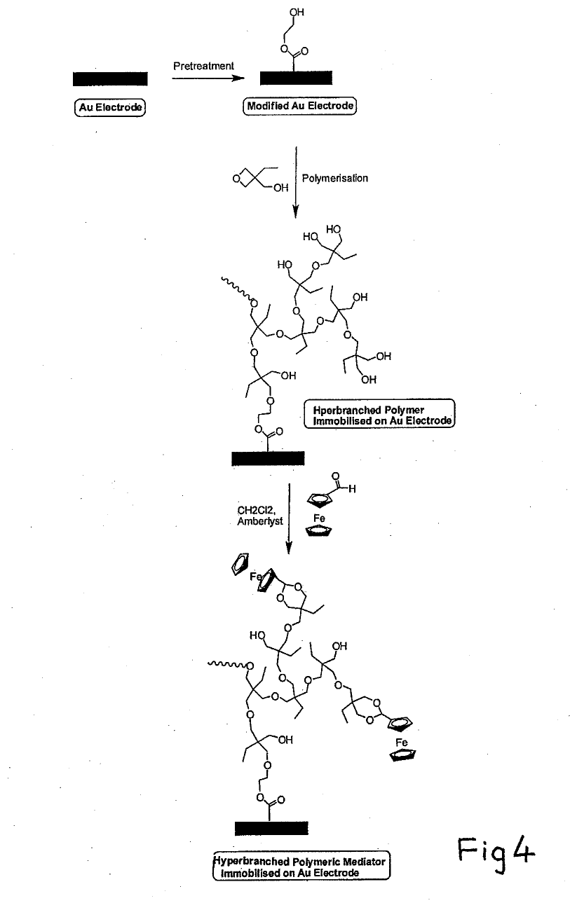

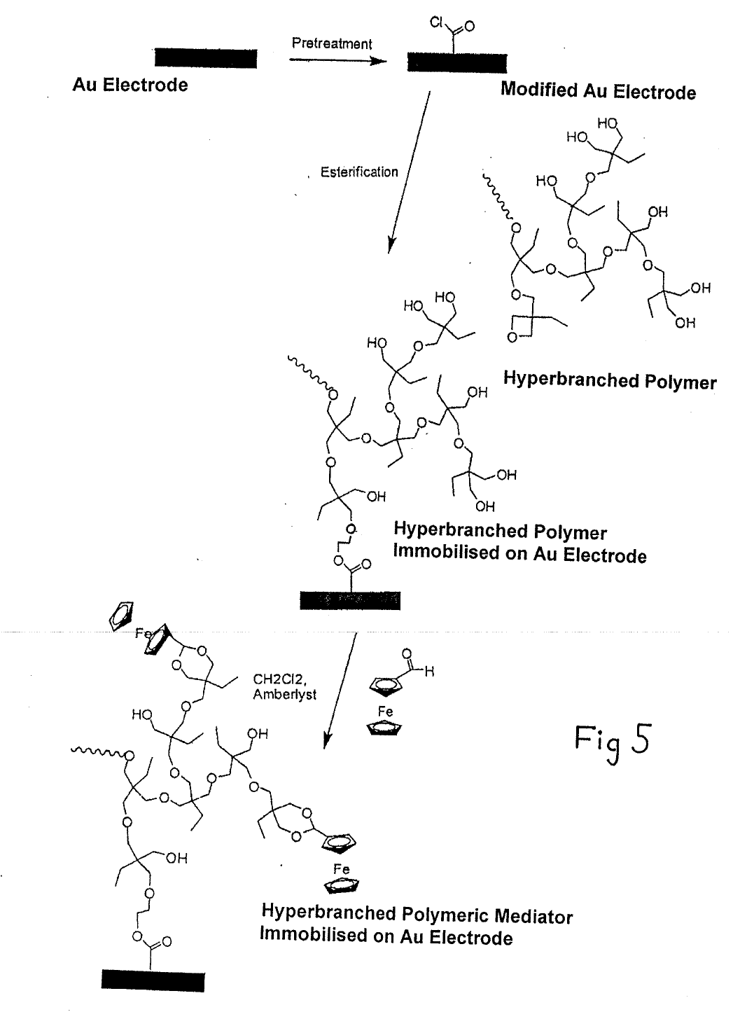

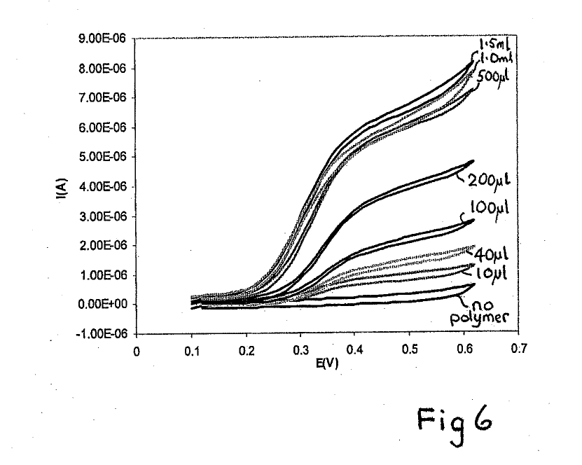

An example of such chemically direct attachment via covalent bonding is depicted in FIG. 4 according to an exemplary embodiment of the present invention. Carboxylic acid groups are first introduced on the surface of a gold (Au) electrode and then converted into carbonyl chloride groups followed by a reaction with ethylene glycol to produce hydroxy end groups. A hyperbranched polymeric mediator can be initialised on these end groups (namely, graft-from approach) in accordance with the method provided in FIG. 3. Alternatively, a preformed hyperbranched polymeric mediator can also be covalently attached to the modified surface of an electrode (namely, graft-to approach). For example, as depicted in FIG. 5, in a two-step reaction, a synthesised HBP will firstly be attached to the carbonyl chloride groups on an Au electrode via ester links and then modified with functional redox mediators on the polymer surface according to the method described in FIG. 3.

For indirect attachment, at least one hyperbranched polymeric mediator is indirectly immobilised on the surface of an electrode via the employment of additional material. In other words, the additional material is attached by the hyperbranched polymeric mediator in prior to its immobilisation on the electrode surface. The additional material may comprise nanomaterials (e.g. nanotube), conductive or semi-conductive polymers (e.g. polypyrrole), metal (e.g. platinum), carbon, and any combination thereof. The attachment of at least one hyperbranched polymeric mediator to the additional material and the attachment of the additional material to the electrode surface, can be physical or chemical by any suitable technique know to those of skill in the art.

While the present invention has been described with specificity in accordance with certain of its preferred embodiments, the following examples serve only to illustrate the invention and are not intended to limit the same. If sources are not specifically described materials are known and commercially available. The practice of the present invention employs, unless otherwise indicated, conventional techniques which are within the skill of the art and which are explained fully in literature.

### EXAMPLES

### Example 1

### Synthesis of a Hyperbranched Polymeric Mediator of FIG. 2

Ferrocenedimethanol (166.80 mg), trimethylolpropane tryglicydyl ether (512 μL) and tert-butyl ammonium chloride (23.55 mg) were placed in a 5 ml vial. The mixture was heated at 120° C. in an oil bath, and stirred at a constant rate. After 22 hours, the crude product was purified by precipitating it into water after its dissolution in THF. The product was dried under vacuum for two days.

### Example 2

### Electrochemical Evaluation of the Hyperbranched Polymeric Mediator Synthesised in Example 1

Cyclic voltammetry (CV) was carried in μAutolab equipment with a type III potentiostat, supported with GPES software (Eco Chemie, Netherlands). A gold electrode was used as working electrode, counter electrode was a platin wire and measurements were referenced toward an Ag/AgCl reference electrode in KCl saturated solution. All the CV measurement were carried out at 150 mv/s scan rate and scanned four times for each sample.

15 ml of phosphate buffer was prepared with pH=7.4 and a 1M glucose solution was made in this phosphate buffer. 1 ml of hyperbranched polymeric mediator product synthesised in Example 1 was then dissolved in 7 ml of THF.

The first CV measurement was carried out after adding 125 mg of glucose oxidase and 1.5 ml of glucose solution (1M) to the phosphate buffer (15 ml). Then 1 ml of hyperbranched polymeric mediator sample was added followed by the CV measurement.

A set of CV plots was determined for samples containing no polymer, and 0.5 ml, 1 ml, 1.5 ml, 2.0 ml and 2.5 ml. The curves moved to progressively higher currents as the polymer concentrations increased.

### Example 3

Schiff base hyperbranched polymer was prepared by reaction of ferrocene dialdehyde (Fc—(CHO)₂) with N (CH₂NH₂)₃ in a refluxing mixture at 80° C. with monomer ratio of 3:2 in absolute ethanol solvent. It was catalysed by amberlyst proton exchange beads and excess molecular sieves are added to remove the water produced in order to shift the equilibrium to the product side. The final polymer was made after reduction by NaBH4 and purification by a column containing Biorad beads.

CV tests were performed as in Example 2, with increased volumes of Schiff base hyperbranched polymer in a glucose/glucose oxidase system. The results are shown in FIG. 6

While the invention has been illustrated above by reference to preferred embodiments, it will be understood by those skilled in the art that various changes and modifications may be made without departing from the spirit and scope of the invention. It is intended to cover all such changes and modifications by the appended claims.

1. An electrode assembly comprising an electrode and a redox mediator associated with the electrode so that in use it facilitates transfer of electrons between the electrode and a further entity, wherein the redox mediator comprises a hyperbranched polymer including a plurality of redox mediator moieties.

2. An assembly according to claim 1 which further includes a redox enzyme which constitutes said further entity.

3. An assembly according to claim 1 wherein said redox mediator is attached to said electrode.

4. An assembly according to claim 3 wherein said redox mediator is directly immobilised on a surface of the electrode.

5. An assembly according to claim 4 wherein said redox mediator is covalently bonded to the electrode.

6. An assembly according to claim 3 wherein said redox mediator is indirectly attached to the electrode via an intermediary material.

7. An assembly according to claim 1 wherein said hyperbranched polymer has a polymer framework and the redox mediator moieties are chemically incorporated within said framework.

8. An assembly according to claim 1 wherein said hyperbranched polymer has a polymer framework having a periphery, and at least some of the redox mediator moieties are chemically anchored on said periphery.

9. An assembly according to claim 1 wherein said redox mediator moieties comprise one or more of ferrocenyl, ferri/ferrocyanide, quinone, osmium, methylene blue, 2,6-dichloroindophenol, thionine, gallocyanine, indophenol, and ethyl phenazene redox mediator moieties.

10. A redox mediator which comprises a hyperbranched polymer including a plurality of redox mediator moieties.

11. A redox mediator according to claim 10 wherein said hyperbranched polymer has a polymer framework and the redox mediator moieties are chemically incorporated within said framework.

12. A redox mediator according to claim 10 wherein said hyperbranched polymer has a polymer framework having a periphery, and at least some of the redox mediator moieties are chemically anchored on said periphery.

13. A redox mediator according to claim 10 wherein said redox mediator moieties comprise one or more of ferrocenyl, ferri/ferrocyanide, quinone, osmium, methylene blue, 2,6-dichloroindophenol, thionine, gallocyanine, indophenol, and ethyl phenazene redox mediator moieties.

14. A method of making a polymeric redox mediator comprising carrying out a polymerisation reaction of a mixture of monomers under conditions such that a hyperbranched polymer is produced, wherein at least some of the monomers comprise redox mediator moieties.

15. A method of making a polymeric redox mediator comprising carrying out a polymerisation reaction of a mixture of monomers under conditions such that a hyperbranched polymer is produced, said hyperbranched polymer having a polymer framework with a periphery with exposed functional groups; and attaching redox mediator moieties to said polymer periphery by means of said functional groups.

16. An electrochemical-based sensor including an electrode assembly according to claim 1.

17. An enzyme-based biofuel cell including an electrode assembly according to claim 1.
